(19) United States
(12) Patent Application Publication
(10) Pub. No.: US 2026/0210000 A1
(43) Pub. Date: Jul. 23, 2026

(54) INORGANIC MATERIAL MANUFACTURING METHOD, INORGANIC MATERIAL MANUFACTURING APPARATUS, AND STRUCTURE

(71) Applicant: HITACHI, LTD., Tokyo (JP)

(72) Inventors: Takeshi KONDO, Tokyo (JP); Satoshi ISHII, Tokyo (JP); Shohei TERADA, Tokyo (JP)

(21) Appl. No.: 19/137,678

(22) PCT Filed: Jan. 15, 2024
(86) PCT No.: PCT/JP2024/000829

§ 371 Date: Jun. 11, 2025

(30) Foreign Application Priority Data
May 29, 2023 (JP) 2023-087746

(51) Int. Cl. D01G 11/00; B01J 6/00; B01J 23/72; B01J 23/75; B09B 3/40; B09B 3/70; B09B 101/75; C03C 13/00

(52) U.S. Cl. CPC D01G 11/00; B01J 6/008; B01J 23/72; B01J 23/75; B09B 3/40; B09B 3/70; C03C 13/00; B09B 2101/75; D10B 2101/06; D10B 2101/12

(57) ABSTRACT

An inorganic material manufacturing method according to the present disclosure includes a contact step, an atmosphere control step, and a heating step. The contact step is a step in which a composite material containing an organic material composed of an organic substance and an inorganic material composed of an inorganic substance is brought into contact with a decomposition promoting component which promotes thermal decomposition of the organic material and contains copper as a main component in a mass ratio among contained transition metal elements. The atmosphere control step is a step in which an atmosphere in a space where a mixture containing the composite material and the decomposition promoting component is present is controlled to gas containing oxygen. The heating step is a step in which the composite material and the decomposition promoting component are heated in an oxidizing atmosphere in a state of being in contact with each other.

### TECHNICAL FIELD

The present disclosure relates to an inorganic material manufacturing method, an inorganic material manufacturing apparatus, and a structure.

### BACKGROUND ART

With the situation of environmental regulations, energy saving, or the like, weight reduction for aircraft, railway vehicles, automobiles, or the like has been promoted. Among them, weight reduction and rigidity improvement are achieved by applying a composite material, such as fiber-reinforced resins containing an inorganic substance such as an inorganic fiber, a filler, or the like, to a constituent member. On the other hand, the composite material contains a plurality of materials, and there is a need to separate the inorganic substance for recycling the composite material.

The abstract of PTL 1 describes “includes a step in which, when a fuel is manufactured from a treatment target containing a polymeric organic substance, an oxide semiconductor and a catalyst containing a transition metal element are brought into contact with the treatment target, and furthermore, a step in which the treatment target, which is contacted with the oxide semiconductor and the catalyst containing the transition metal element, is heated in an atmosphere containing hydrogen and oxygen”.

### CITATION LIST

### Patent Literature

PTL 1: JP 2022-55446 A

### SUMMARY OF INVENTION

### Technical Problem

Paragraph 0033 of PTL 1 describes that the oxide semiconductor and the transition metal element can be combined to promote an oxidative decomposition reaction and to lower a treatment temperature. Although the details will be described later with reference to examples, the present inventors have studied and found that when a decomposition promoting component that promotes thermal decomposition of an organic material contains, as a main component, copper at a mass ratio in the contained transition metal elements, a thermal decomposition temperature can be lowered as compared with the case of using another transition metal element.

A problem to be solved by the present disclosure is to provide an inorganic material manufacturing method, an inorganic material manufacturing apparatus, and a structure capable of performing thermal decomposition at a lower temperature than conventional methods.

### Solution to Problem

An inorganic material manufacturing method according to the present disclosure includes a heating step in which a composite material which contains an organic material composed of an organic substance and an inorganic material composed of an inorganic substance, and a decomposition promoting component which promotes thermal decomposition of the organic material and contains copper as a main component in a mass ratio among transition metal elements contained are heated in an oxidizing atmosphere in a state of being in contact with each other. Other solutions will be described later in a mode for carrying out the invention.

### Advantageous Effects of Invention

According to the present disclosure, it is possible to provide the inorganic material manufacturing method, the inorganic material manufacturing apparatus, and the structure capable of performing thermal decomposition at a lower temperature than conventional methods.

### BRIEF DESCRIPTION OF DRAWINGS

FIG. 1 is a flowchart illustrating an inorganic material manufacturing method according to the present disclosure.

FIG. 2 s a flowchart illustrating an inorganic material manufacturing method according to another embodiment.

FIG. 3 is a flowchart illustrating an inorganic material manufacturing method according to another embodiment.

FIG. 4 is a perspective view illustrating an inside of an inorganic material manufacturing apparatus of the present disclosure in a transparent manner.

FIG. 5 is a perspective view illustrating an inside of an inorganic material manufacturing apparatus according to another embodiment in a transparent manner.

FIG. 6 is a perspective view of a structure of the present disclosure.

FIG. 7 is a perspective view of a structure according to another embodiment.

FIG. 8 is a graph illustrating a decomposition behavior of each decomposition promoting component.

FIG. 9 is a graph illustrating a decomposition behavior of each decomposition promoting component according to another example.

### DESCRIPTION OF EMBODIMENTS

Hereinafter, modes for carrying out the present disclosure (referred to as embodiments) will be described with reference to the drawings. In the following description of one embodiment, another embodiment applicable to one embodiment will also be described as appropriate. The present disclosure is not limited to the following one embodiment, and may be combined with a different embodiment or may be modified in any manner within a range not significantly impairing the effects of the present disclosure. In addition, the same members are denoted by the same reference numerals, and redundant description will be omitted. Furthermore, those having the same function are denoted by the same name. The illustrated contents are merely schematic, and for convenience of illustration, an actual configuration may be changed within a range not significantly impairing the effects of the present disclosure, or illustration of some members may be omitted or modified between the drawings. In addition, all the configurations are not necessarily provided in the same embodiment.

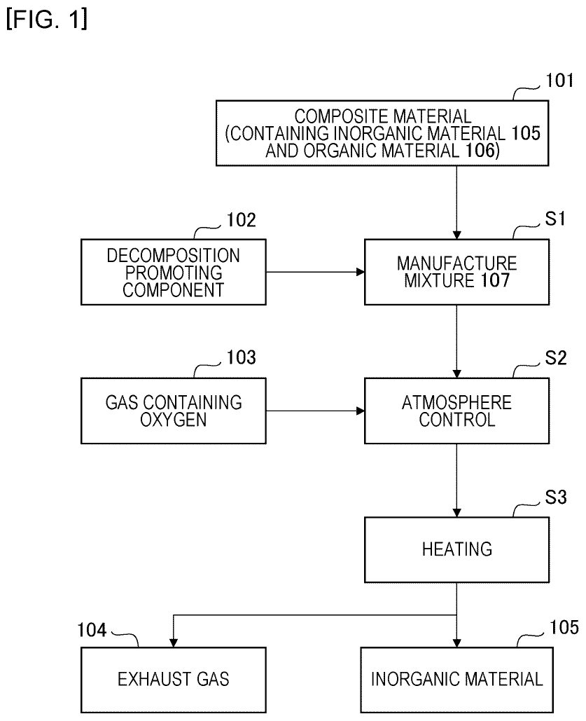

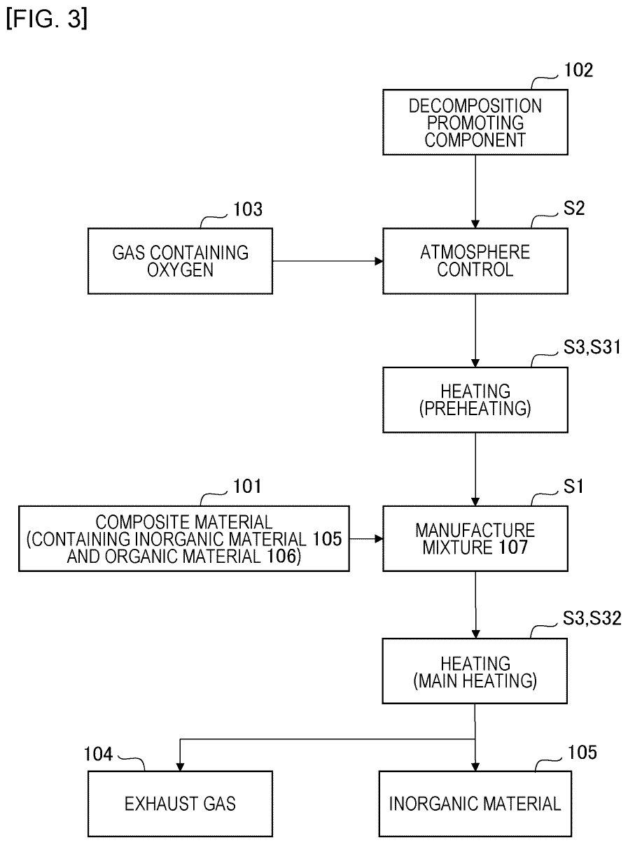

FIG. 1 is a flowchart illustrating a method for manufacturing an inorganic material 105 of the present disclosure (hereinafter, simply referred to as a “manufacturing method of the present disclosure” as appropriate). The manufacturing method illustrated in FIG. 1 can be executed by, for example, manufacturing apparatus 200 illustrated in FIG. 4 to be described later.

The manufacturing method of the present disclosure is a method for manufacturing the inorganic material 105 from a composite material 101 containing the inorganic material 105 and an organic material 106. As the composite material 101, for example, so-called “waste plastic” obtained from waste such as home electric appliances (washing and drying machine, refrigerator, vacuum cleaner, water heater, or the like), aircraft, railway vehicles, automobiles, and industrial products can be used. Therefore, the manufacturing method of the present disclosure can also be said to be a method for recycling the composite material 101 and the inorganic material 105. The manufactured inorganic material 105 can be reused as a part of a new composite material 101, for example, as a recycled material.

The inorganic material 105 in the composite material 101 that separates (collects) the inorganic material 105 may be a virgin material or a recycled material. As the recycled material, for example, the inorganic material 105 manufactured by the manufacturing method of the present disclosure can be used. Hereinafter, when simply referred to as the “inorganic material 105”, the inorganic material 105 may be either the virgin material or the recycled material unless otherwise specified.

In the manufacturing method of the present disclosure, the organic material 106 in the composite material 101 is thermally decomposed at a lower temperature (for example, 440° C. or lower, preferably 400° C. or lower) than conventional methods. In the present disclosure, since the thermal decomposition (thermal decomposition reaction) of the organic material 106 is performed in an oxidizing atmosphere, it can also be said to be oxidative decomposition. By the thermal decomposition at a lower temperature than conventional methods, it is possible to suppress the inorganic material 105 contained together with the organic material 106 from being deteriorated due to heat, and to suppress a change in physical properties such as a decrease in the strength of the inorganic material 105. Accordingly, it is possible to manufacture a new composite material 101 having physical properties comparable to the physical properties of the composite material 101 using the inorganic material 105 as the virgin material.

The inorganic material 105 contained in the composite material 101 is composed of an inorganic substance. Examples of the inorganic substance include an inorganic fiber, an inorganic filler, and a metal. Examples of the inorganic fiber include a glass fiber, an asbestos fiber, a carbon fiber, a silica fiber, a silica-alumina fiber, an alumina fiber, a zirconia fiber, a potassium titanate fiber, a tyranno fiber, a silicon carbide fiber, and a metal fiber. These fibers can be used alone or in combination of two or more. These fibers are used in a form of continuous fibers, long fibers, short fibers, chopped or the like, and in a form of a unidirectional material, plain weave, nonwoven fabric or the like. However, a fiber form or fiber state is not limited to these fiber forms or fiber states.

Examples of the inorganic filler include a powder such as fused silica, crystalline silica, alumina, zircon, calcium silicate, calcium carbonate, potassium titanate, silicon carbide, aluminum nitride, boron nitride, beryllia, zircon, forsterite, steatite, spinel, mullite, and titania, and beads obtained by spheroidizing these powders. The shape of the inorganic filler is not limited, and any shape such as a spherical shape and a scaly shape may be used.

Examples of the metal contained in the inorganic material 105 include steel, aluminum, an aluminum alloy, a magnesium alloy, and a titanium alloy. In addition, the shape of the metal is not limited, and any shape such as a plate shape, a spherical shape, and a scaly shape may be used.

Among them, the inorganic substance preferably contains at least one type of the carbon fiber or the glass fiber. These are often used, for example, to improve the strength of the composite material 101. For this reason, the composite material 101 has high strength, but due to the high strength, it is difficult to extract (separate) the inorganic material 105 from the composite material 101 by, for example, crushing the composite material 101. However, according to the manufacturing method of the present disclosure, as described above, the thermal decomposition temperature of the organic material 106 can be lowered as compared with conventional methods. Therefore, the organic material 106 can be easily thermally decomposed, and the inorganic material 105 can be extracted (manufactured) from the composite material 101.

The organic material 106 is composed of an organic substance, and the organic substance contains, for example, a resin such as a thermosetting resin or a thermoplastic resin. Examples of the thermosetting resin include an epoxy resin, a phenol resin, a urea resin, a melamine resin, an unsaturated polyester resin, a silicone resin, a polyimide resin, a bismaleimide resin, and a thermosetting urethane resin. Examples of the thermoplastic resin include polyethylene, polypropylene, polystyrene, acrylonitrile butadiene styrene, polyvinyl chloride, a methacrylic resin, polyethylene terephthalate, polybutylene terephthalate, polyvinyl alcohol, polyamide, and polycarbonate. The resin may be used alone as a single type, or may be used in any arbitrary ratio or proportion of two or more types.

Among them, the organic substance preferably contains a thermosetting resin. Since the thermosetting resin is cured by heating, it is difficult to melt the organic material 106, and it is difficult to separate the inorganic material 105, which is contained together with the organic material 106, from the organic material 106. However, according to the manufacturing method of the present disclosure, the thermal decomposition temperature of the organic material 106 can be lowered as compared with conventional methods, so that the organic material 106 can be easily thermally decomposed, and the inorganic material 105 can be extracted (manufactured) from the composite material 101.

The composite material 101 may, if necessary, contain additives such as a flame retardant, an antioxidant, a light stabilizer, a dispersant, a lubricant, a plasticizer, an antistatic agent, a pigment, and a dye.

The manufacturing method Of the present disclosure includes a contact step S1, an atmosphere control step S2, and a heating step S3. The contact step S1 is a step of bringing the composite material 101 into contact with a decomposition promoting component 102. In the present disclosure, mixing is exemplified as an example of the contact. Therefore, the contact of the composite material 101 with the decomposition promoting component 102 manufactures a mixture 107 containing the composite material 101 and the decomposition promoting component 102. Note that the “mixing” does not need to be performed to such an extent that the entire composite material 101 and the entire decomposition promoting component 102 are completely and uniformly mixed, and for example, the composite material 101 and the decomposition promoting component 102 may coexist inside a same reaction tank 1 (FIG. 4).

A manner of the contact is not particularly limited. For example, the composite material 101 pulverized into a rod shape having a length of about 1 mm to 10 mm can be mixed with a powdery (for example, 10 μm or more and 500 μm or less as a particle size based on a laser diffraction scattering method) decomposition promoting component 102. The mixing can be executed, for example, by placing the composite material 101 and the decomposition promoting component 102 in the reaction tank 1 (FIG. 4. a container or the like). In addition, the decomposition promoting component 102 may be attached to a wall surface of the reaction tank 1 and a structure such as a stirring mechanism 5 (FIG. 4), and the composite material 101 may be brought into contact with the attached decomposition promoting component 102.

The decomposition promoting component 102 promotes the thermal decomposition of the organic material 106 and contains, as a main component (preferably more than 50 mass %, more preferably 100 mass %), copper in a mass ratio in the transition metal elements contained in the decomposition promoting component 102. The decomposition promoting component 102 contains components that do not change during the thermal decomposition of the organic material 106 (for example, copper (II) oxide or the like) and components that change during the thermal decomposition (for example, copper (I) oxide, organic copper, or the like). Among these, the decomposition promoting component 102 that does not change during the thermal decomposition can be referred to as, for example, a “catalyst”.

The decomposition promoting component 102 contains copper. The copper referred to herein may be pure copper or a copper compound. By containing copper, when the decomposition promoting component 102 is heated in an oxidizing atmosphere, the copper in the decomposition promoting component 102 is oxidized to generate copper (II) oxide. However, in a case where the decomposition promoting component 102 contains the copper (II) oxide, the copper (II) oxide contained from the beginning does not usually change. Heating of the copper (II) oxide causes thermal excitation inside the copper (II) oxide to generate holes and electrons. The holes deprive the electrons from organic substances present around the copper (II) oxide by their oxidizing power, thereby oxidatively decomposing the organic substances. In addition, the electrons generated by the thermal excitation undergo electron transfer to oxygen contained in the atmosphere, thereby generating reactive oxygen species. Since the reactive oxygen species promote oxidative decomposition of the organic substance, the organic substance is also oxidatively decomposed by this process.

It has been found that the thermal decomposition can be executed at a low temperature (for example, 440° C. or lower, preferably 400° C. or lower) by using the decomposition promoting component 102 capable of mainly generating the copper (II) oxide, among various oxides, during the thermal decomposition. Unlike other oxides, a mechanism by which the copper (II) oxide can oxidatively decompose the organic substance at a low temperature is not necessarily clear. However, according to the study of the present inventors, it is considered that this is due to the high activity (reactivity) of the copper (II) oxide, the valence of copper contained in the copper (II) oxide, the ease of generation of holes and electrons in the copper (II) oxide, or the like. Note that the mechanism is merely presumption and is not limited to this content, and there may be other possible reasons.

The decomposition promoting component 102 contains copper as a main component as described above. The term “main component” referred to herein means that the component has the largest mass ratio in the transition metal elements contained in the decomposition promoting component 102 (for example, in a case where there are two types of transition metal elements, copper is more than 50 mass %). Then, the decomposition promoting component 102 preferably contains at least one of pure copper or a compound containing copper as a main component (hereinafter, referred to as a copper compound). As the copper compound, for example, copper oxide, an organic copper compound, a copper alloy, or the like can be obtained. Examples of the copper oxide include copper (I) oxide (Cu₂O) and copper (II) oxide (CuO). Examples of the organic copper compound include copper (II) acetate and copper acetylacetonate (II). Only one type of copper compound may be used, or two or more types thereof may be used at an arbitrary ratio and proportion.

Among them, the decomposition promoting component 102 preferably contains pure copper. Accordingly, the entire pure copper can be oxidized to copper (II) oxide, and the amount copper (II) oxide involved in the thermal decomposition of the organic material 106 can be increased. As a result, the amount of the organic material 106 to be thermally decomposed can be increased, and the treatment efficiency of the composite material 101 can be improved.

In addition, the decomposition promoting component 102 preferably contains at least one type of the copper (I) oxide or the copper (II) oxide. Since copper is easily naturally oxidized by oxygen, even the copper (II) oxide that can naturally oxidize can be used as the decomposition promoting component.

In addition, the decomposition promoting component 102 preferably contains an organic copper compound. Since the organic copper compound has a carbon skeleton, it has excellent affinity with the organic material 106. Therefore, the organic copper compound easily acts on the organic material 106, and can easily promote the thermal decomposition of the organic material 106.

The decomposition promoting component 102 preferably does not contain an oxide semiconductor (excluding copper oxide). The copper oxide referred to herein is copper (II) oxide and copper (I) oxide. Although the copper oxide is an oxide semiconductor, using the copper oxide among oxide semiconductors enables the thermal decomposition of the organic material 106 at a lower temperature than in a case where another oxide semiconductor is used. Therefore, by not containing an oxide semiconductor other than copper oxide, the organic material 106 can be thermally decomposed at a low temperature. However, although it is preferable that an oxide semiconductor other than copper oxide is not contained, the oxide semiconductor other than copper oxide may be contained in a supplemental manner.

Specifically, the decomposition promoting component 102 may contain, in a supplemental manner, at least one compound of a compound which is a thermally stable oxide semiconductor or a compound which generates a thermally stable oxide semiconductor by heating with the organic material 106. Examples of such a compound include at least one type of CaO, MnO, ZrO₂, WO₂, TiO₂, V₂O₅, Cr₂O₃, NiO, Fe₂O₃, Fe₃O₄, ZnO, CoO, Co₃O₄, or the like.

The decomposition promoting component 102 preferably does not contain a transition metal element (excluding copper). By using copper among transition metals, copper (II) oxide can be generated during heating in an oxidizing atmosphere. Then, as described above, the thermal decomposition of the organic material 106 can be performed at a lower temperature by the copper (II) oxide than in a case where another transition metal element is used. Therefore, by not containing a transition metal element other than copper, the organic material 106 can be thermally decomposed at a low temperature. However, although it is preferable not to contain a transition metal element other than copper, the transition metal element other than copper may be contained in a supplemental manner.

The content of the decomposition promoting component 102 with respect to the organic material 106 is preferably 50 mass % or more. By setting the use amount of the decomposition promoting component 102 within this range, the organic material 106 can be thermally decomposed. However, the content of the decomposition promoting component 102 can be appropriately adjusted depending on the shapes of the organic material 106 and the decomposition promoting component 102. The upper limit of the content is not particularly limited, and may be appropriately determined according to the manufacturing cost of the inorganic material 105, the internal volume of the reaction tank 1 (FIG. 4), or the like.

The decomposition promoting component 102 preferably has a particle shape (for example, a powder shape). By having such a shape, a contact area with the organic material 106 can be increased, and the thermal decomposition of the organic material 106 occurring at a contact portion between the decomposition promoting component 102 and the organic material 106 can be promoted.

The atmosphere control step S2 (FIG. 1) is a step of controlling an atmosphere at the contact portion where the composite material 101 and the decomposition promoting component 102 are brought into contact with each other. In the example of the present disclosure, for example, an atmosphere in a space where the mixture 107 obtained in the contact step S1 is present (the atmosphere in the internal space of the reaction tank 1 (FIG. 4) ) is controlled. In the atmosphere control step S2, the atmosphere in the space where the mixture 107 is arranged is controlled to gas 103 containing oxygen. That is, the mixture 107 is present in the gas 103. The gas 103 is, for example, air, oxygen gas, or the like.

Note that in a case where at least one of the composite material 101 or the decomposition promoting component 102 contains a component that generates oxygen during the heating step S3, the atmosphere control step S2 may not be included. In a case where atmosphere control step S2 is not included, the copper in the decomposition promoting component 102 is oxidized by the oxygen generated from at least one of the composite material 101 or the decomposition promoting component 102 during the heating step S3. Therefore, as a result, the heating step S3 of heating the composite material 101 and the decomposition promoting component 102 in the oxidizing atmosphere in the state of being in contact with each other is performed.

The heating step S3 is a step of heating the composite material 101 and the decomposition promoting component 102 in the oxidizing atmosphere in the state of being in contact with each other. In the example of the present disclosure, the heating step S3 is a step of heating the mixture 107 present in the gas 103.

The heating step S3 is performed by heating at a temperature at which the organic material 106 is thermally decomposed. By heating at this temperature, the organic material 106 can be thermally decomposed.

However, the heating step S3 is preferably performed by heating at a temperature of, for example, 440° C. or lower, preferably 420° C. or lower, and more preferably 400° C. or lower as a temperature at which the organic material 106 is thermally decomposed. For example, by heating at 440° C. or lower, preferably 420° C. or lower, and more preferably 400° C. or lower, it is possible to suppress the thermal deterioration of the inorganic material 105 which causes a significant influence in the reuse of the recycled inorganic material 105. In addition, the heating step S3 is preferably performed by heating at a temperature of, for example, 200° C. or higher, preferably 250° C. or higher, more preferably 300° C. or higher, and particularly preferably 350° C. or higher.

A heating time in the heating step S3 is not particularly limited, but heating can be performed for a time of, for example, 5 minutes or more and 1 hour or less.

The thermal decomposition of the organic material 106 causes the solid organic material 106 to change into exhaust gas 104. The exhaust gas 104 contains, for example, carbon dioxide and is appropriately exhausted to the outside. On the other hand, the inorganic material 105 contained in the composite material 101 remains in the reaction tank 1 (FIG. 4). Therefore, the inorganic material 105 can be extracted from the reaction tank 1.

The heating step S3 is preferably performed while at least one of vibration and stirring is performed on at least one of the composite material 101 or the decomposition promoting component 102 in a state where the composite material 101 and the decomposition promoting component 102 are brought into contact with (for example, mixed with) each other. By executing the heating step S3 in this manner, as compared with the case of performing the heating step S3 with the materials left stationary, it is possible to increase a contact opportunity between the composite material 101 and the decomposition promoting component 102 and to promote the thermal decomposition of the organic material 106.

The heating step S3 is preferably performed using the reaction tank 1 (FIG. 4) used in the contact step S1. The thermal decomposition of the organic material 106 can be continuously executed by performing the contact step S1 and the heating step S3 using the same reaction tank 1.

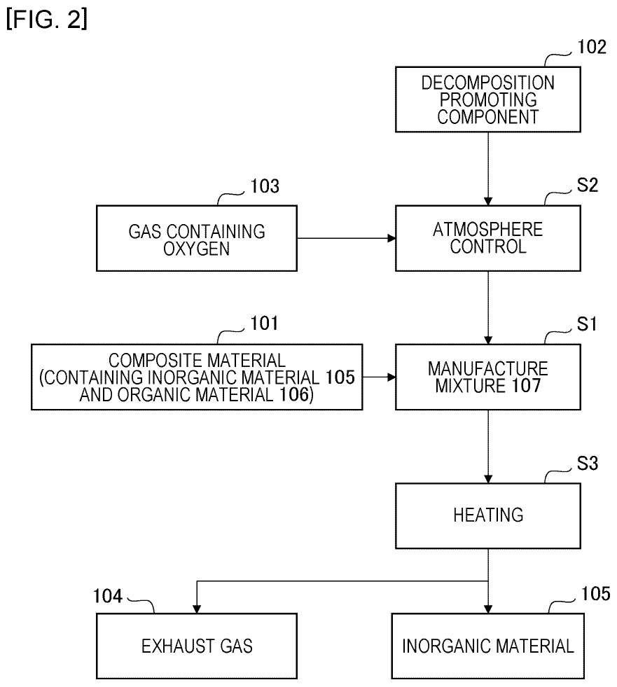

FIG. 2 is a flowchart illustrating a method for manufacturing the inorganic material 105 according to another embodiment. In the embodiment illustrated in FIG. 2, unlike the embodiment illustrated in FIG. 1, the contact step S1 is executed after the atmosphere control step S2. Specifically, for example, the atmosphere in the internal space of the reaction tank 1 (FIG. 4) in which the decomposition promoting component 102 is arranged is composed of the gas 103 containing oxygen (atmosphere control step S2). Therefore, the decomposition promoting component 102 is present in the gas 103. Then, by further accommodating the composite material 101 in the reaction tank 1 in this state, the atmosphere of the mixture 107 is composed of the gas 103 (contact step S1).

According to the embodiment illustrated in FIG. 2, the organic material 106 can be oxidatively decomposed at a lower temperature than conventional methods.

FIG. 3 is a flowchart illustrating a method for manufacturing the inorganic material 105 according to another embodiment. In the embodiment illustrated in FIG. 3, which is different from the embodiment illustrated in FIG. 2, the heating step S3 includes a preheating step S31 and a main heating step S32. After the atmosphere control step S2, the preheating step S31 that is a part of the heating step S3 is performed. The preheating step S31 is a step of raising the temperature of the decomposition promoting component 102 to the heating temperature in the main heating step S32 described later. After the temperature of the decomposition promoting component 102 is raised to a desired temperature, the composite material 101 is charged into the reaction tank to manufacture the mixture 107 (contact step S1). Then, the main heating step S32 is executed on the mixture 107. The main heating step S32 can be executed similarly to the heating step S3 described with reference to FIG. 1 or the like.

According to the embodiment illustrated in FIG. 3, the organic material 106 can be oxidatively decomposed at a lower temperature than conventional methods. Further, since the composite material 101 is brought into contact with the preheated decomposition promoting component 102, it is possible to shorten a time from when the composite material 101 is brought into contact with the decomposition promoting component 102 until the temperature of the composite material is raised to a temperature at which the composite material can be thermally decomposed. Accordingly, the treatment time of the composite material 101 can be shortened.

FIG. 4 is a perspective view illustrating the inside of the manufacturing apparatus 200 of the inorganic material 105 (FIG. 1) of the present disclosure in a transparent manner. The manufacturing apparatus 200 includes the reaction tank 1, a heating mechanism 2, an air supply port 3, an exhaust port 4, and the stirring mechanism 5. The reaction tank 1 accommodates the composite material 101 and the decomposition promoting component 102. In the example illustrated in FIG. 4, the composite material 101 broken (crushed) into an elongated rod shape is embedded in the powdery decomposition promoting component 102. The reaction tank 1 is, for example, a hollow tank. The heating mechanism 2 heats the composite material 101 and the decomposition promoting component 102 inside the reaction tank 1. The heating mechanism 2 is provided at the bottom of the reaction tank 1, and heats the composite material 101 and the decomposition promoting component 102 from the bottom of the reaction tank 1. The heating mechanism 2 is, for example, an electric heating wire, a boiler, or the like.

The air supply port 3 (air supply pipe) supplies the gas 103 containing oxygen into the reaction tank 1. The exhaust port 4 (exhaust pipe) exhausts, as the exhaust gas 104, gas generated inside the reaction tank 1 from the reaction tank 1. The gas exhausted from the exhaust port 4 includes gas (for example, carbon dioxide, water vapor, or the like) generated by the thermal decomposition of the organic material 106. When the organic material 106 is exhausted as gas from the reaction tank 1, the inorganic material 105 remains inside the reaction tank 1, and the inorganic material 105 can be easily extracted. The air supply port 3 and the exhaust port 4 are provided in the upper portion of the reaction tank 1.

The stirring mechanism 5 stirs the composite material 101 and the decomposition promoting component 102 inside the reaction tank 1. By providing the stirring mechanism 5, as compared with a case where reaction is performed with the materials left stationary, it is possible to increase a contact opportunity between the composite material 101 and the decomposition promoting component 102 and to promote the thermal decomposition of the organic material 106 generated at a contact portion between the composite material 101 and the decomposition promoting component 102. The stirring mechanism 5 is, for example, a stirring blade or the like, and in the illustrated example, the stirring blade is embedded in the powdery decomposition promoting component 102.

As described above, the composite material 101 and the decomposition promoting component 102 are in contact with each other inside the reaction tank 1. Then, the gas 103 containing oxygen is supplied to the inside of the reaction tank 1 through the air supply port 3. Further, the composite material 101 and the decomposition promoting component 102 present inside the reaction tank 1 are heated by the heating mechanism 2. Thus, the manufacturing method of the present disclosure (for example, FIG. 1) can be executed. In addition, the exhaust gas 104 generated by the decomposition reaction is exhausted from the reaction tank 1 through the exhaust port 4. The inorganic material 105 remaining inside the reaction tank 1 by the thermal decomposition of the organic material 106 can be extracted, for example, through an upper opening of the reaction tank 1 using an arbitrary jig (not illustrated). The extraction can be performed, for example, after the supply of the gas 103 and the driving of the stirring mechanism 5 are stopped.

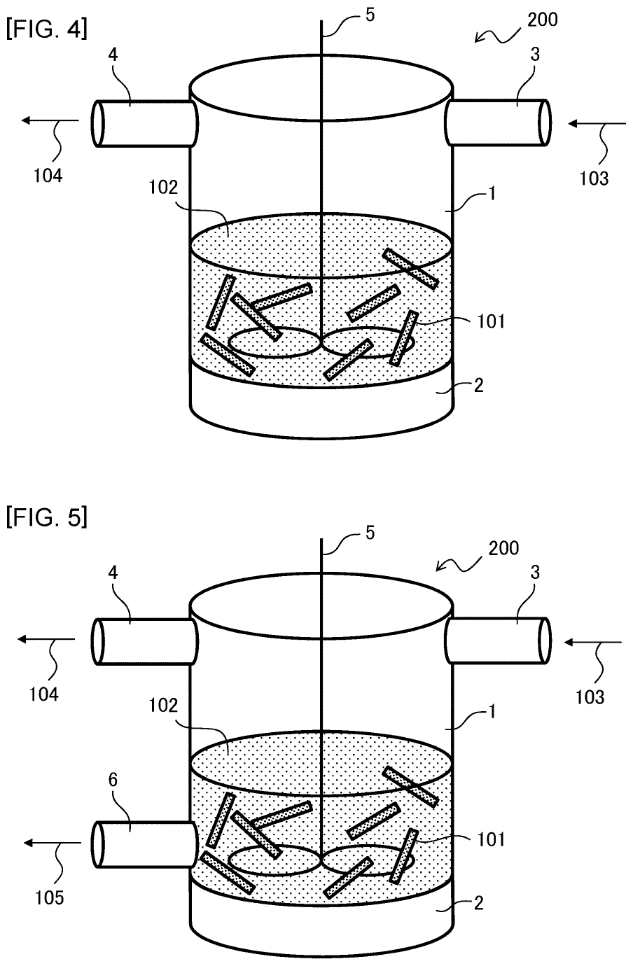

FIG. 5 is a perspective view illustrating the inside Of the manufacturing apparatus 200 of the inorganic material 105 according to another embodiment in a transparent manner. The manufacturing apparatus 200 illustrated in FIG. 5 further includes a collection mechanism 6 in the manufacturing apparatus 200 illustrated in FIG. 4. The collection mechanism 6 collects the inorganic material 105 obtained by the thermal decomposition of the organic material 106 in the composite material 101 from the inside of the reaction tank 1. By providing the collection mechanism 6, the inorganic material 105 can be easily collected from the inside of the reaction tank 1.

In the example of the present disclosure, the collection mechanism 6 is an extraction port (extraction pipe) provided on the lower side of the reaction tank 1 The inorganic material 105 can be separated using a difference in specific gravity, shape, or the like from the decomposition promoting component 102, SO that the inorganic material 105 therein can be collected. The extraction port is preferably provided in a portion close to the bottom surface of the reaction tank 1.

The manufacturing method Of the present disclosure using the manufacturing apparatus 200 illustrated in FIG. 5 can be continuously executed. Specifically, for example, the inorganic material 105 is manufactured by thermally decomposing the organic material 106 inside the reaction tank 1 by the manufacturing method of the present disclosure. After the manufacturing, the supply of the gas 103 and the driving of the stirring mechanism 5 are stopped, and the collection mechanism 6 collects the inorganic material 105. After the collection, an arbitrary conveyance mechanism (not illustrated) supplies the composite material 101 and the decomposition promoting component 102 to the inside of the reaction tank 1 through, for example, a raw material supply port (not illustrated) of the reaction tank 1. Then, the manufacturing method of the present disclosure is executed again.

FIG. 6 is a perspective view of a structure 110 of the present disclosure. FIG. 6 illustrates a member 112 provided in the structure 110, and the member 112 is a plate material in the example of FIG. 6. The member 112 is composed of a composite material 111. The composite material 111 is, for example, a composite material newly manufactured using the inorganic material 105 manufactured by the manufacturing method illustrated in FIG. 1 or the like.

For example, the structure 110 is an arbitrary structure such as railway vehicles, ship, aircraft, automobiles, wind power generation, unit baths, septic tanks, printed circuit boards, playground equipment, or ski boards, and the member 112 can be used as an arbitrary member constituting the arbitrary structure 110. For example, the member 112 can be used for a blade in wind power generation, a railway vehicle underframe, a window frame, a portion for extracting winding of a stator constituting a motor, a portion for extracting a permanent magnet constituting a rotor, a constituent member of an inverter, or the like.

The member 112 contains the inorganic material 105 (FIG. 1) which is manufactured at least through the heating step S3 (FIG. 1) of heating the composite material 101 (FIG. 1) and the decomposition promoting component 102 (FIG. 1) in a state of being in contact with each other in the oxidizing atmosphere. According to the structure 110 including the member 112 and the member 112, the amount of the inorganic material 105 to be discarded can be reduced. In addition, the strength of the member 112 containing the newly manufactured composite material 111 is reduced to such an extent that there is no large influence in the use of the composite material 111 as compared with the physical properties (for example, strength) of the composite material 111 manufactured using the inorganic material 105 which is a virgin material. Therefore, for example, the member 112 and the structure 110 having physical properties such as desired strength can be obtained.

Note that, regarding physical properties, the physical properties of the inorganic material 105 of the virgin material do not strictly match the physical properties of the inorganic material 105 obtained by the manufacturing method of the present disclosure (that is, obtained by recycling the composite material 101). Specifically, the physical properties of the inorganic material 105 are changed at least slightly by heating for the thermal decomposition of the organic material 106. However, the degree of the change varies depending on heating conditions such as conditions at the time of thermal decomposition (for example, the heating temperature and the heating time) and the shape of the composite material 101 at the time of recycling. Therefore, it is impossible or impractical to quantitatively evaluate the physical properties of the inorganic material 105 obtained by recycling the composite material 101. In this regard, in the example of the present disclosure, the feature of the structure 110 is specified by the method for manufacturing the structure 110.

In addition, when the structure 110 is viewed, whether the structure 110 is manufactured using the inorganic material 105 which is a virgin material or manufactured using the inorganic material 105 obtained by recycling the composite material 101 can be grasped by evaluating the physical properties (for example, mechanical strength) of the inorganic material 105. That is, when the evaluated mechanical strength is the same as (or substantially the same as) the mechanical strength of the virgin material, it can be said that the structure 110 is manufactured using the inorganic material 105 which is a virgin material. On the other hand, when the evaluated mechanical strength is lower than the mechanical strength of the virgin material, but there is no significant influence on the use of the structure 110, it can be said that the structure 110 is manufactured using the inorganic material 105 obtained by recycling the composite material 101.

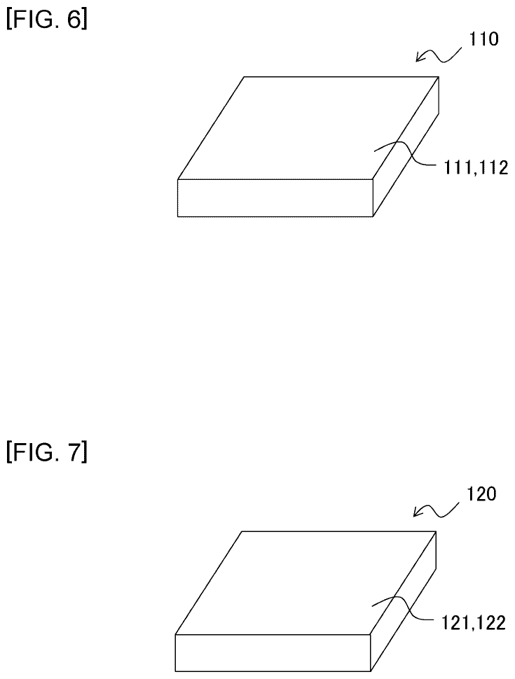

FIG. 7 is a perspective view of a structure 120 according to another embodiment. The structure 120 includes a member 122. The member 122 is composed of a composition 121 containing the composite material 101 (FIG. 1) and a decomposition promoting component 102 (FIG. 1). The decomposition promoting component 102 is, for example, inherently present in the organic material 106 in the composite material 101. Therefore, for example, the inorganic material 105 and the decomposition promoting component 102 are dispersed in the organic material 106.

According to structure 120 illustrated in FIG. 7, the inorganic material 105 can be separated by executing the heating step S3 on the used structure 120 as is. Therefore, since the contact step S1 (FIG. 1) can be reduced, recycling can be easily performed.

### EXAMPLES

Hereinafter, the present disclosure will be described more specifically with reference to examples.

### Example 1

A bisphenol A diglycidyl ether type thermosetting epoxy resin was used as the organic material 106 (FIG. 1), and glass fiber was used as the inorganic material 105 (FIG. 1) to prepare a glass fiber reinforced resin (GFRP) as the composite material 101 (FIG. 1). The content of the inorganic material 105 in the composite material 101 was set to 50 mass %. Therefore, the content of the organic material 106 in the composite material 101 is also 50 mass %. The composite material 101 was broken into chips having a length of 5 mm, a width of 2 mm, and a thickness of about 0.2 mm.

Copper (II) oxide (CuO) was prepared as the decomposition promoting component 102 (FIG. 1). The copper (II) oxide had an average particle size (D50) of 100 μm measured with a laser diffraction particle size distribution analyzer. The chip-shaped composite material 101 and the decomposition promoting component 102 were mixed (contact step S1) to obtain the mixture 107. The content of the decomposition promoting component 102 in the mixture 107 was set to 50 mass %. Therefore, the content of the composite material 101 in the mixture 107 is also 50 mass %. Therefore, the content of the decomposition promoting component 102 with respect to the organic material 106 in the composite material 101 is 200 mass %.

The decomposition behavior of the organic material 106 was analyzed using the mixture 107. The analysis was performed 1 a thermal mass reduction device. As analysis conditions (decomposition conditions of the organic material 106), the temperature was raised from room temperature to 700° C. at 10° C./min. Here, a temperature at which the mass of the organic material 106 reached 5% (that is, the organic material 106 hardly remained) was defined as a decomposition temperature, and the decomposition temperature of 440° C. or lower was evaluated as being decomposable at a low temperature. As a result of the analysis, the decomposition temperature was 362° C., and it was confirmed that the organic material 106 could be decomposed at 440° C. or lower.

### Example 2

The decomposition temperature was analyzed in a manner similar to Example 1 except that copper (I) oxide (Cu₂O) was used instead of copper (II) oxide. As a result, the decomposition temperature was 372° C.

### Example 3

The decomposition temperature was analyzed in a manner similar to Example 1 except that pure copper (Cu) was used instead of copper (II) oxide. As a result, the decomposition temperature was 377° C.

### Example 4

The decomposition temperature was analyzed in a manner similar to Example 1 except that copper (II) acetylacetonate (Cu(C₅H₇O₂)₂) was used instead of copper (II) oxide. As a result, the decomposition temperature was 392° C.

### Example 5

The decomposition temperature was analyzed in a manner similar to Example 1 except that a mixture obtained by mixing copper (II) oxide and titanium oxide (TiO₂) at a mass ratio of 55:45 was used instead of copper (II) oxide. As a result, the decomposition temperature was 377° C.

### Example 6

The decomposition temperature was analyzed in a manner similar to Example 5 except that the mass ratio of copper (II) oxide and titanium oxide was changed to 75:25. As a result, the decomposition temperature was 376° C.

### Example 7

The decomposition temperature was analyzed in a manner similar to Example 5 except that cobalt oxide (CoO) was used instead of titanium oxide. As a result, the decomposition temperature was 363° C.

### Example 8

The decomposition temperature was analyzed in a manner similar to Example 7 except that the mass ratio of copper (II) oxide and cobalt oxide was changed to 75:25. As a result, the decomposition temperature was 356° C.

### Example 9

The decomposition temperature was analyzed in a manner similar to Example 1 except that a carbon fiber was used instead of the glass fiber. As a result, the decomposition temperature was 364° C.

### Example 10

The decomposition temperature was analyzed in a manner similar to Example 1 except that an unsaturated polyester resin which is a thermosetting resin was used instead of the bisphenol A diglycidyl ether type epoxy resin. As a result, the decomposition temperature was 366° C.

### Example 11

The decomposition temperature was analyzed in a manner similar to Example 1 except that the content of the decomposition promoting component 102 in the mixture 107 was changed from 50 mass % to 20 mass %. Therefore, the content of the decomposition promoting component 102 with respect to the organic material 106 in the composite material 101 is 50 mass %. As a result, the decomposition temperature was 381° C.

### Example 12

The decomposition temperature was analyzed in a manner similar to Example 1 except that the content of the decomposition promoting component 102 in the mixture 107 was changed from 50 mass % to 80 mass %. Therefore, the content of the decomposition promoting component 102 with respect to the organic material 106 in the composite material 101 is 800 mass %. As a result, the decomposition temperature was 377° C.

### Example 13

The decomposition temperature was analyzed in a manner similar to Example 1 except that the content of the decomposition promoting component 102 in the mixture 107 was changed from 50 mass % to 4.8 mass %. Therefore, the content of the decomposition promoting component 102 with respect to the organic material 106 in the composite material 101 is 10 mass %. As a result, the decomposition temperature was 412° C.

In Example 13, the decomposition temperature exceeded 400° C., but was lower than the decomposition temperature in Comparative Examples 1 to 7 (described later) describing a conventional technique. Therefore, by using the decomposition promoting component 10, the decomposition temperature can be lowered as compared with conventional methods. However, it has been found that, for further lowering the temperature, the content of the decomposition promoting component 102 with respect to the organic material 106 in the composite material 101 is preferably 50 mass % or more (Examples 1 to 12).

### Comparative Example 1

The decomposition temperature was analyzed in a manner similar to Example 1 except that titanium oxide was used instead of copper (II) oxide. As a result, the decomposition temperature was 505° C.

### Comparative Example 2

The decomposition temperature was analyzed in a manner similar to Example 1 except that dichromic acid (Cr₂O₃) was used instead of copper (II) oxide. As a result, the decomposition temperature was 495° C.

### Comparative Example 3

The decomposition temperature was analyzed in a manner similar to Example 1 except that zinc oxide (ZnO₂) was used instead of copper (II) oxide. As a result, the decomposition temperature was 492° C.

### Comparative Example 4

The decomposition temperature was analyzed in a manner similar to Example 1 except that nickel oxide (NiO) was used instead of copper (II) oxide. As a result, the decomposition temperature was 514° C.

### Comparative Example 5

The decomposition temperature was analyzed in a manner similar to Example 5 except that the mass ratio of copper (II) oxide and titanium oxide was changed to 25:75. As a result, the decomposition temperature was 445° C.

### Comparative Example 6

The decomposition temperature was analyzed in a manner similar to Example 1 except that copper-supported titanium oxide was used instead of copper (II) oxide. In the copper-supported titanium oxide, the transition metal element which is a main component in terms of mass ratio among the transition metal elements contained is titanium. As a result of the analysis, the decomposition temperature was 456° C.

### Comparative Example 7

The decomposition temperature was analyzed in a manner similar to Example 1 except that iron-supported titanium oxide was used instead of copper (II) oxide. In the iron-supported titanium oxide, the transition metal element which is a main component in terms of mass ratio among the transition metal elements contained is titanium. As a result of the analysis, the decomposition temperature was 500° C.

### Summary

From the above results, according to the present disclosure, it has been confirmed that the decomposition temperature can be set to, for example, 440° C. or lower, and the decomposition temperature can be particularly lowered as compared with a case where a transition metal element other than copper is a main component.

### Difference in Decomposition Behavior Due to Difference in Transition Metal Element

The same thermosetting resin was used except that the metal oxide was variously changed, the content of the thermosetting resin and the metal oxide was set to 1:1 in mass ratio, and the decomposition behavior was analyzed in a manner similar to Example 1.

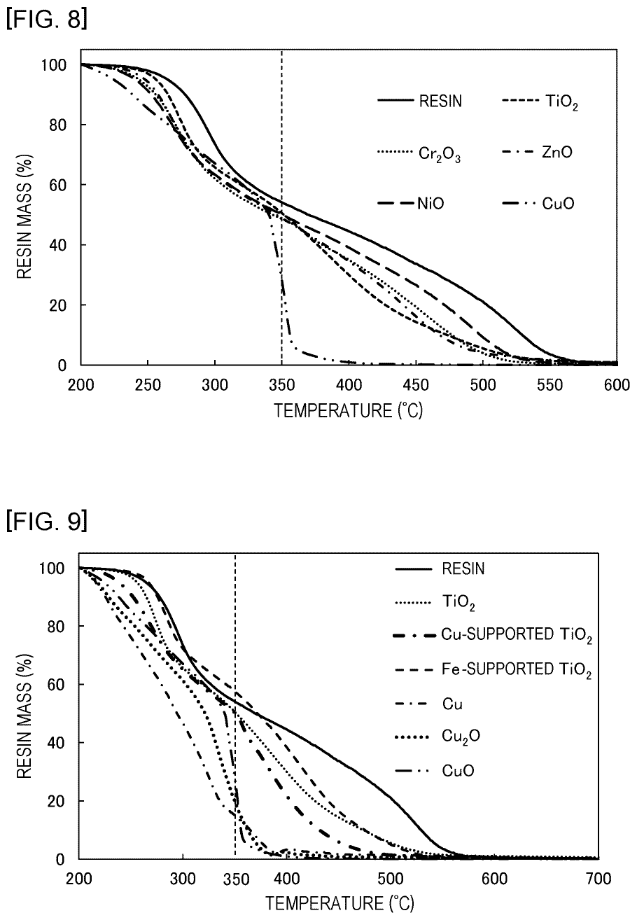

FIG. 8 is a graph illustrating the decomposition behavior of each decomposition promoting component 102. The graph illustrated in FIG. 8 illustrates a difference in decomposition temperature due to a difference in transition metal element as a main component contained in the decomposition promoting component 102. The transition metal elements used are chromium (dotted line), nickel (broken line), titanium (broken line more finely divided than the broken line indicating nickel), zinc (one-dot chain line), and copper (II) (two-dot chain line). Among them, copper (II) is an example, and chromium, nickel, titanium, and zinc are all comparative examples. All transition metal elements are contained in the resin in the form of an oxide. A vertical axis represents mass, and a horizontal axis represents temperature. The vertical axis represents a relative ratio with the mass at the start of heating as 100%. FIG. 8 illustrates a change in mass reduction when the temperature of a sample is raised in the thermal mass reduction device used in Example 1. As a reference, “resin” indicated by a solid line is a reference example not containing the decomposition promoting component 102. This point is similar in FIG. 9 described later.

In all the examples, a mass reduction due to the temperature rise of the sample was observed. This means that the organic material 106 is thermally decomposed by the temperature rise of the sample. In particular, in the oxides (comparative examples) other than copper (II) oxide, the mass gradually decreased with the temperature rise. When copper (II) oxide (example) was used, the mass rapidly decreased when the temperature of the sample was raised to about 350° C., and the mass decreased to about 0%. This result means that the thermal decomposition of the organic material 106 rapidly proceeded at a specific temperature (about 350° C.). The reason for this is not necessarily clear and the present invention is not limited to this reason, but according to the study of the present inventors, it is considered that the thermal decomposition proceeded in a chain manner. Therefore, it is found that the thermal decomposition of the organic material 106 can be promoted by using copper (II) oxide, and as a result, the thermal decomposition can be performed at a lower temperature than using another metal.

FIG. 9 is a graph illustrating the decomposition behavior of each decomposition promoting component 102 according to another example. The conditions were the same as those illustrated in FIG. 8 except that the decomposition promoting component 102 was different, and the change in mass reduction was analyzed. The decomposition promoting components 102 are titanium oxide (thin dotted line), copper-supported titanium oxide (thick one-dot chain line), iron-supported titanium oxide (broken line), pure copper (thin one-dot chain line), copper (I) oxide (thick dotted line), and copper (II) oxide (two-dot chain line). As described above, in both copper-supported titanium oxide and iron-supported titanium oxide, the transition metal element which is a main component in mass ratio among the transition metal elements contained is titanium. Therefore, among these, pure copper, copper (I) oxide, and copper (II) oxide are examples, and titanium oxide, copper-supported titanium oxide, and iron-supported titanium oxide are all comparative examples.

In a case where the decomposition promoting component 102 contained copper as a main component, that is, in pure copper (thin one-dot chain line), copper (I) oxide (thick dotted line), and copper (II) oxide (two-dot chain line), the mass thereof was almost 0% at 400° C. or lower. In particular, when copper oxide which is copper (I) oxide and copper (II) oxide, or pure copper is used, the mass rapidly decreased at about 350° C. as described above with reference to FIG. 8. Among the composite materials 101, there may be the composite material 101 which is used at a relatively high temperature. Therefore, by using the decomposition promoting component 102 the mass of which gently changes until the temperature becomes relatively high and rapidly decreases at a specific temperature, the degree of mass reduction can be suppressed to be small even in a case where the composite material 101 is used at a relatively high temperature (however, at a specific temperature or lower).

### REFERENCE SIGNS LIST

1 reaction tank
101 composite material
102 decomposition promoting component
103 gas
104 exhaust gas
105 inorganic material
106 organic material
107 mixture
110 structure
111 composite material
112 member
120 structure
122 member
2 heating mechanism
200 manufacturing apparatus
3 air supply port
4 exhaust port
5 stirring mechanism
6 collection mechanism
S1 contact step
S2 atmosphere control step
S3 heating step
S31 preheating step
S32 main heating step

1. An inorganic material manufacturing method comprising:
a heating step in which
a composite material which contains an organic material composed of an organic substance and an inorganic material composed of an inorganic substance, and
a decomposition promoting component which promotes thermal decomposition of the organic material and contains copper as a main component in a mass ratio among transition metal elements contained
are heated in an oxidizing atmosphere in a state of being in contact with each other.

2. The inorganic material manufacturing method according to claim 1, wherein
the inorganic substance contains at least one type of carbon fiber or glass fiber.

3. The inorganic material manufacturing method according to claim 1, wherein
the decomposition promoting component contains pure copper.

4. The inorganic material manufacturing method according to claim 1, wherein
the decomposition promoting component contains at least one type of copper (I) oxide or copper (II) oxide.

5. The inorganic material manufacturing method according to claim 1, wherein
the decomposition promoting component contains an organic copper compound.

6. The inorganic material manufacturing method according to claim 1, wherein
the decomposition promoting component has a particle shape.

7. The inorganic material manufacturing method according to claim 1, wherein
the organic substance contains a thermosetting resin.

8. The inorganic material manufacturing method according to claim 1, wherein
the heating step is performed by heating at a temperature at which the organic material is thermally decomposed.

9. The inorganic material manufacturing method according to claim 8, wherein
the heating step is performed by heating at a temperature of 400° C. or lower.

10. The inorganic material manufacturing method according to claim 1, wherein
the heating step is performed while at least one of vibration and stirring is performed on at least one of the composite material or the decomposition promoting component in a state where the composite material and the decomposition promoting component are in contact with each other.

11. The inorganic material manufacturing method according to claim 1, comprising:
a contact step in which the composite material and the decomposition promoting component are brought into contact with each other, wherein
the heating step is performed using a reaction tank used in the contact step.

12. The inorganic material manufacturing method according to claim 1, wherein
the decomposition promoting component does not contain an oxide semiconductor (excluding copper oxide).

13. The inorganic material manufacturing method according to claim 1, wherein
the decomposition promoting component does not contain a transition metal element (excluding copper).

14. The inorganic material manufacturing method according to claim 1, wherein
a content of the decomposition promoting component relative to the organic material is 50 mass % or more.

15. An inorganic material manufacturing apparatus comprising:
a reaction tank which accommodates a composite material which contains an organic material composed of an organic substance and an inorganic material composed of an inorganic substance, and
a decomposition promoting component which promotes thermal decomposition of the organic material and contains copper as a main component in a mass ratio among transition metal elements contained;
a heating mechanism which heats the composite material and the decomposition promoting component inside the reaction tank;
an air supply port for supplying gas containing oxygen into the reaction tank; and
an exhaust port for exhausting gas, which is generated inside the reaction tank, from the reaction tank.

16. The inorganic material manufacturing apparatus according to claim 15, comprising:
a stirring mechanism which stirs the composite material and the decomposition promoting component inside the reaction tank.

17. The inorganic material manufacturing apparatus according to claim 15, comprising:
a collection mechanism which collects the inorganic material, which is obtained by the thermal decomposition of the organic material in the composite material, from an inside of the reaction tank.

18. The inorganic material manufacturing apparatus according to claim 15, wherein
the gas exhausted from the exhaust port includes gas generated by thermal decomposition of the organic material.

19. A structure comprising:
a member which contains an inorganic material composed of an inorganic substance which is manufactured at least through a heating step in which
a composite material which contains an organic material composed of an organic substance and the inorganic material, and
a decomposition promoting component which promotes thermal decomposition of the organic material and contains copper as a main component in a mass ratio among transition metal elements contained
are heated in an oxidizing atmosphere in a state of being in contact with each other.
